(19) United States
(12) Patent Application Publication
(10) Pub. No.: US 2016/0289517 A1
(43) Pub. Date: Oct. 6, 2016

(54) ADHESIVE FILM AND DISPLAY MEMBER COMPRISING THE SAME

(71) Applicant: SAMSUNG SDI CO., LTD., Yongin-si (KR)

(72) Inventors: Seon Hee SHIN, Suwon-si (KR); Hyung Rang MOON, Suwon-si (KR); Il Jin KIM, Suwon-si (KR)

(21) Appl. No.: 15/084,361

(22) Filed: Mar. 29, 2016

(30) Foreign Application Priority Data
Mar. 31, 2015 (KR) 10-2015-0045770

(51) Int. Cl. C09J 133/14; C09J 7/02

(52) U.S. Cl. CPC C09J 133/14; C09J 7/02; C09J 2433/00

(57) ABSTRACT

Disclosed are an adhesive film and a display member including the same. The adhesive film includes a matrix including a (meth)acrylic copolymer containing hydroxyl group and nanoparticles dispersed in the matrix, wherein a difference in cohesive energy between the matrix and the nanoparticles is about 20,000 J/mol or less.

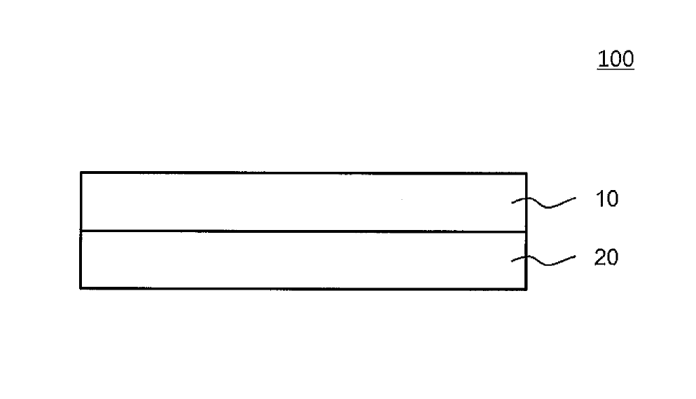

### CROSS-REFERENCE TO RELATED APPLICATION

This application claims priority to and the benefit of Korean Patent Application No. 10-2015-0045770, filed on Mar. 31, 2015 in the Korean Intellectual Property Office, the entire disclosure of which is incorporated herein by reference.

### BACKGROUND

1. Field

The following description relates to an adhesive film and a display member including the same.

2. Description of the Related Art

A transparent adhesive film is used as an adhesive film in interlayer bonding for stacking parts in an optical display or in attachment of a touchscreen of a mobile phone.

For example, a capacitive touch pad among optical displays is attached to a window or film via an adhesive film, and has properties thereof by sensing a change in the capacitance of the window or film. An adhesive film in touch pads is stacked between a window glass and a TSP sensor glass.

The transparent adhesive film may improve the clarity of a screen as compared with existing double-sided tapes and may exhibit good adhesion while acting like glass by transmitting 97% or more of light. The transparent adhesive film may be used for tablet PCs and TVs including a medium or large display screen, as well as for mobile phones.

Recently, along with severer environments of using, storing and/or manufacturing optical displays and an increasing interest in flexible optical displays and the like, transparent adhesive films are required to have various properties. Thus, there is a need for a transparent adhesive film which exhibits good properties in terms of warpage, adhesion, durability, and transparency under severe conditions.

### SUMMARY

In accordance with one embodiment of the present invention, an adhesive film may include: a matrix including a (meth)acrylic copolymer containing hydroxyl group; and nanoparticles dispersed in the matrix, wherein a difference in cohesive energy between the matrix and the nanoparticles may be about 20,000 J/mol or less.

In accordance with another embodiment of the present invention, an adhesive film may include: a matrix including a (meth)acrylic copolymer containing hydroxyl group; and nanoparticles dispersed in the matrix, and the adhesive film may have a haze of about 1% or less, as measured after the adhesive film has been left under conditions of 25° C. and 80% RH for 8 hours, and a warpage value of about 0.15 mm or less. The warpage value refers to the highest height difference value among height difference values between a central point on the adhesive film and six other points on the adhesive film (four corner points of the adhesive film and two middles points on two 100 mm long sides thereof) on a flat surface, as measured after the adhesive film (size: 60 mm×100 mm×60 mm×100 mm, thickness: 100 μm) has been left under conditions of 60° C. and 90% RH for 500 hours.

In accordance with a further embodiment of the present invention, a display member may include an optical film and an adhesive film attached to one or both surfaces of the optical film.

### BRIEF DESCRIPTION OF DRAWING

The drawing is a cross-sectional view of a display member according to one embodiment of the present invention.

### DETAILED DESCRIPTION

As used herein, the term “(meth)acrylate” may refer to acrylates and/or methacrylates.

As used herein, the term “copolymer” may include oligomers, polymers, or resins.

As used herein, the term “cohesive energy” refers to a value calculated according to Group Contribution Equation stated in Polymer Eng. and Sci. (Fedors, R. F., 1974, 14,147), the entire content of which is incorporated herein by reference.

As used herein, the term “warpage value” refers to the greatest height difference value among height difference values between a central point and six other points on the adhesive film (four corner points of the adhesive film and two middles points on two 100 mm long sides thereof) on a flat surface, as measured after the adhesive film (size: 60 mm×100 mm×60 mm×100 mm, thickness: 100 μm) has been left under conditions of 60° C. and 90% RH for 500 hours.

As used herein, the term “average particle diameter” refers to a particle diameter of the nanoparticles, as measured in a water-based solvent or organic solvent using a Zetasizer nano-ZS (Malvern Co., Ltd.) and expressed by Z-average value.

As used herein, the term “core-shell structure” may refer to typical core-shell structures including structures having several layers of cores or shells, and the term “core-shell particles” refers to nanoparticles having a core-shell structure.

As used herein, the term “shell” refers to an outermost layer of the core-shell structure and may also refer to nanoparticles per se when the nanoparticles are provided in the form of a single layer.

As used herein, the term “adhesive strength” at 25° C. refers to the 90° adhesive strength, as measured on a manufactured adhesive film (thickness: 100 μm), which was attached to a polyethylene terephthalate (PET) film (thickness: 35 μm) and subjected to aging at 25° C. for 30 minutes, using a TA.XT_Plus texture analyzer at 25° C. and at a peeling rate of 50 mm/min.

As used herein, the term “adhesive strength” at 60° C. refers to the 90° adhesive strength, as measured on a manufactured adhesive film (thickness: 100 μm), which was attached to a PET film (thickness: 35 μm) and subjected to aging at 25° C. for 1 day (i.e., 24 hours) and at 60° C. for 30 minutes sequentially, using a TA.XT_Plus texture analyzer at 60° C. and at a peeling rate of 50 mm/min.

As used herein, the terms “substantially,” “about,” and similar terms are used as terms of approximation and not as terms of degree, and are intended to account for the inherent deviations in measured or calculated values that would be recognized by those of ordinary skill in the art. Expressions such as “at least one of” or “at least one selected from” when preceding a list of elements, modify the entire list of elements and do not modify the individual elements of the list. Further, the use of “may” when describing embodiments of the present invention refers to “one or more embodiments of the present invention.” Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In some embodiments, an adhesive film may include a matrix including a (meth)acrylic copolymer containing hydroxyl group; and nanoparticles dispersed in the matrix, wherein a difference in the cohesive energy between the matrix and the nanoparticles may be about 20,000 J/mol or less.

In other embodiments, the adhesive film may include: a matrix including a (meth)acrylic copolymer containing hydroxyl group; and nanoparticles dispersed in the matrix, and the adhesive film may have a haze of about 1% or less in the visible range, as measured after the adhesive film has been left under conditions of 25° C. and 80% RH (relative humidity) for 8 hours, and a warpage value of about 0.15 mm or less. The warpage value refers to the highest height difference value among height difference values between a central point on the adhesive film and six other points on the adhesive film (four corner points of the adhesive film and two middles points on two 100 mm long sides thereof) on a flat surface, as measured after the adhesive film (size: 60 mm×100 mm×60 mm×100 mm, thickness: 100 μm) has been left under conditions of 60° C. and 90% RH for 500 hours.

The adhesive film may be formed of an adhesive composition, which includes the (meth)acrylic copolymer containing hydroxyl group and the nanoparticles.

Hereinafter, the adhesive composition will be described in more detail.

### Adhesive Composition

The adhesive composition may include the (meth)acrylic copolymer containing hydroxyl group and nanoparticles.

The (meth)acrylic copolymer containing hydroxyl group may be a copolymer of a monomer mixture including a (meth)acrylic monomer containing hydroxyl group, and a monomer (e.g., a second monomer), a homopolymer of which (e.g., a homopolymer of the second monomer) has a glass transition temperature Tg of about −150° C. to about 0° C.

The (meth)acrylic monomer containing hydroxyl group may be a (meth)acrylic ester having a C₁ to C₂₀ alkyl group having at least one hydroxyl group, a C₅ to C₂₀ cycloalkyl group having at least one hydroxyl group, or a C₆ to C₂₀ aryl group having at least one hydroxyl group. For example, the (meth)acrylic monomer containing hydroxyl group may include at least one of 2-hydroxyethyl (meth)acrylate, 4-hydroxybutyl (meth)acrylate, 2-hydroxypropyl (meth)acrylate, 2-hydroxybutyl (meth)acrylate, and 6-hydroxyhexyl (meth)acrylate, without being limited thereto. For example, the adhesive composition may include a (meth)acrylic monomer having a C₁ to C₁₀ alkyl group having a hydroxyl group, such as a (meth)acrylic monomer having a C₁ to C₅ alkyl group having a hydroxyl group, thereby enabling adjustment of the cohesive energy of the matrix. By adjusting the cohesive energy using the (meth)acrylic copolymer containing hydroxyl group of the adhesive composition, the adhesive film may have improved warpage characteristics, adhesive strength, transparency and durability.

The (meth)acrylic monomer containing hydroxyl group may be present in an amount of about 5% by weight (wt %) to about 35 wt %, for example, about 10 wt % to about 30 wt %, or about 10 wt % to about 25 wt % based on the total amount of the monomer mixture. Within this range, the adhesive film may achieve balance (e.g., a balanced performance) among warpage characteristics, adhesive strength, transparency and durability.

As the monomer (e.g., the second monomer), a homopolymer of which has a glass transition temperature Tg of about −150° C. to about 0° C., any monomer may be used without limitation so long as the homopolymer of the monomer has a glass transition temperature Tg of about −150° C. to about 0° C. For example, a monomer, a homopolymer of which has a glass transition temperature Tg of about −150° C. to about −20° C., or, a monomer, a homopolymer of which has a glass transition temperature Tg of about −150° C. to about −40° C., may be used. In one embodiment, the monomer may include at least one of an alkyl (meth)acrylate monomer, a monomer containing ethylene oxide, a monomer containing propylene oxide, a monomer containing amine group, a monomer containing amide group, a monomer containing alkoxy group, a monomer containing phosphoric acid group, a monomer containing sulfonic acid group, a monomer containing phenyl group, and a monomer containing silane group, without being limited thereto. The glass transition temperature of the homopolymer of each of the monomers may be measured using a DSC Q20 (TA Instrument Inc.). Specifically, the homopolymer of each of the monomers is heated to 100° C. at a rate of 20° C./min, followed by slowly cooling to −180° C. and then heating to 100° C. at a rate of 10° C./min, thereby obtaining data of an endothermic transition curve. An inflection point of the endothermic transition curve is determined as the glass transition temperature.

The alkyl (meth)acrylate monomer may include (meth)acrylic esters having unsubstituted C₁ to C₂₀ linear or branched alkyl group. For example, the alkyl (meth)acrylate monomer may include at least one of ethyl acrylate, propyl acrylate, isopropyl acrylate, n-butyl acrylate, iso-butyl acrylate, pentyl (meth)acrylate, hexyl methacrylate, heptyl (meth)acrylate, ethylhexyl (meth)acrylate, octyl (meth)acrylate, isooctyl (meth)acrylate, nonyl (meth)acrylate, decyl (meth)acrylate, and lauryl (meth)acrylate. For example, the alkyl (meth)acrylate monomer may be a (meth)acrylic monomer having C₄ to C₈ alkyl group, which may further improve the initial adhesion of the adhesive composition.

The monomer containing ethylene oxide may include a (meth)acrylate monomer containing at least one ethylene oxide group (—CH₂CH₂O—). For example, the monomer containing ethylene oxide may include polyethylene oxide alkyl ether (meth)acrylates such as polyethylene oxide monomethyl ether (meth)acrylate, polyethylene oxide monoethyl ether (meth)acrylate, polyethylene oxide monopropyl ether (meth)acrylate, polyethylene oxide monobutyl ether (meth)acrylate, polyethylene oxide monopentyl ether (meth)acrylate, polyethylene oxide dimethyl ether (meth)acrylate, polyethylene oxide diethyl ether (meth)acrylate, polyethylene oxide monoisopropyl ether (meth)acrylate, polyethylene oxide monoisobutyl ether (meth)acrylate, and polyethylene oxide mono-tert-butyl ether (meth)acrylate, without being limited thereto.

The monomer containing propylene oxide may include polypropylene oxide alkyl ether (meth)acrylates such as polypropylene oxide monomethyl ether (meth)acrylate, polypropylene oxide monoethyl ether (meth)acrylate, polypropylene oxide monopropyl ether (meth)acrylate, polypropylene oxide monobutyl ether (meth)acrylate, polypropylene oxide monopentyl ether (meth)acrylate, polypropylene oxide dimethyl ether (meth)acrylate, polypropylene oxide diethyl ether (meth)acrylate, polypropylene oxide monoisopropyl ether (meth)acrylate, polypropylene oxide monoisobutyl ether (meth)acrylate, and polypropylene oxide mono-tert-butyl ether (meth)acrylate, without being limited thereto

The monomer containing amine group may include (meth)acrylic monomers containing amine group such as monomethylaminoethyl (meth)acrylate, monoethylaminoethyl (meth)acrylate, monomethylaminopropyl (meth)acrylate, monoethylaminopropyl (meth)acrylate, dimethylaminoethyl (meth)acrylate, diethylaminoethyl (meth)acrylate, N-tert-butylaminoethyl (meth)acrylate, and (meth)acryloxyethyltrimethyl ammonium chloride (meth)acrylate, without being limited thereto.

The monomer containing amide group may include (meth)acrylic monomers containing amide group such as (meth)acrylamide, N-methyl acrylamide, N-methyl methacrylamide, N-methylol (meth)acrylamide, N-methoxymethyl (meth)acrylamide, N,N-methylene bis(meth)acrylamide, and 2-hydroxyethyl acrylamide, without being limited thereto.

The monomer containing alkoxy group may include 2-methoxyethyl (meth)acrylate, 2-methoxypropyl (meth)acrylate, 2-ethoxypropyl (meth)acrylate, 2-butoxypropyl (meth)acrylate, 2-methoxypentyl (meth)acrylate, 2-ethoxypentyl (meth)acrylate, 2-butoxyhexyl (meth)acrylate, 3-methoxypentyl (meth)acrylate, 3-ethoxypentyl (meth)acrylate, and 3-butoxyhexyl (meth)acrylate, without being limited thereto.

The monomer containing phosphoric acid group may include (meth)acrylic monomers containing phosphoric acid group such as 2-methacryloyloxyethyldiphenylphosphate (meth)acrylate, trim ethacryloyloxyethylphosphate (meth)acrylate, and triacryloyloxyethylphosphate (meth)acrylate, without being limited thereto.

The monomer containing sulfonic acid group may include (meth)acrylic monomers containing sulfonic acid group such as sodium sulfopropyl (meth)acrylate, sodium 2-sulfoethyl (meth)acrylate, and sodium 2-acrylamido-2-methylpropane sulfonate, without being limited thereto.

The monomer containing phenyl group may include (meth)acrylic monomers containing phenyl group such as p-tert-butylphenyl (meth)acrylate and o-biphenyl (meth)acrylate, without being limited thereto.

The monomer containing silane group may include vinyl monomers or (meth)acrylic monomer containing silane group such as 2-acetoacetoxyethyl (meth)acrylate, vinyltrimethoxysilane, vinyltriethoxysilane, vinyl tris(β-methoxyethyl)silane, vinyltriacetylsilane, and methacryloyloxypropyltrimethoxysilane, without being limited thereto.

The monomer, a homopolymer of which has a glass transition temperature Tg of about −150° C. to about 0° C., may be present in an amount of about 65 wt % to about 95 wt %, for example, about 70 wt % to about 90 wt %, or about 75 wt % to about 90 wt %, based on the total amount of the monomer mixture. Within this range, the adhesive film may exhibit excellent adhesive strength and low temperature properties. In one embodiment, the (meth)acrylic copolymer containing hydroxyl group may be a copolymer of a monomer mixture comprising about 10 wt % to about 25 wt % of the (meth)acrylic monomer containing hydroxyl group and about 75 wt % to about 90 wt % of the alkyl (meth)acrylate monomer.

The monomer mixture may further include a monomer containing carboxyl acid group.

The monomer containing carboxyl acid group may include (meth)acrylic acid, 2-carboxyethyl (meth)acrylate, 3-carboxypropyl (meth)acrylate, 4-carboxybutyl (meth)acrylate, itaconic acid, crotonic acid, maleic acid, fumaric acid, and maleic anhydride, without being limited thereto. The monomer containing carboxyl acid group may be present in an amount of about 10 wt % or less, for example, about 7 wt % or less, or about 5 wt % or less, based on the total amount of the monomer mixture. Within this range, the adhesive film may exhibit high adhesive strength and good durability.

An adhesive film formed of the adhesive composition including the nanoparticles may exhibit good warpage characteristics and have a cross-linked structure, thereby securing good durability. In addition, since the nanoparticles of the adhesive composition have a particular average particle diameter, the adhesive film may exhibit excellent transparency despite the presence of the nanoparticles. The nanoparticles may be dispersed in the matrix comprising the (meth)acrylic copolymer containing hydroxyl group. In addition, the nanoparticles may be chemically coupled to the matrix.

A difference in the cohesive energy between the matrix and the nanoparticles may be about 20,000 J/mol or less, for example, about 18,000 J/mol or less, about 16,000 J/mol or less, or, about 15,000 J/mol to about 20,000 J/mol. This range of difference in cohesive energy may provide an advantage of reducing or minimizing phase separation of the nanoparticles from the matrix under severe conditions. The matrix may have a cohesive energy of about 60,000 J/mol or less, for example, about 40,000 J/mol to about 60,000 J/mol, and the nanoparticles may have a cohesive energy of about 40,000 J/mol or less, for example, about 10,000 J/mol to about 40,000 J/mol.

The nanoparticles may have an average particle diameter of about 5 nm to about 1,000 nm, for example, about 10 nm to about 500 nm, about 10 nm to about 300 nm, or about 10 nm to about 200 nm. Within this range of particle diameter, the nanoparticles may be reduced or prevented from agglomeration, and good transparency of the adhesive film may be achieved.

In some embodiments, the nanoparticles may be organic particles. For example, the organic particles may include a (meth)acrylate having a glass transition temperature Tg of about 70° C. or more. The (meth)acrylate having a glass transition temperature Tg of about 70° C. or more may include at least one of polymethyl methacrylate (PMMA), t-butyl methacrylate, cyclohexyl methacrylate, isobornyl acrylate, isobornyl methacrylate, methyl methacrylate and phenyl methacrylate, or a polymer including at least one of these (meth)acrylates, without being limited thereto. The (meth)acrylate having a glass transition temperature Tg of about 70° C. or more may include at least one of, for example, polymethyl methacrylate (PMMA), isobornyl acrylate (IBOA) and isobornyl methacrylate (IBOMA). The nanoparticles including the (meth)acrylate having a glass transition temperature Tg of about 70° C. or more may adjust (e.g., advantageously adjust) the difference in cohesive energy with respect to the adhesive film.

The nanoparticles may be provided in a single layer structure or in a core-shell structure composed of multiple layers. In the nanoparticles having a core-shell structure, the shell may include the (meth)acrylate having a glass transition temperature Tg of about 70° C. or more. The core may include polyalkyl (meth)acrylates, without being limited thereto. For example, the core may include at least one of polymethyl methacrylate (PMMA), polymethyl acrylate, polyethyl (meth)acrylate, polypropyl (meth)acrylate, polybutyl (meth)acrylate, polyisopropyl (meth)acrylate, polyisobutyl (meth)acrylate, and polycyclohexyl (meth)acrylate, without being limited thereto. In some embodiments, the core or the shell may include two or more layers. In the embodiments wherein the core or the shell is composed of two or more layers, an outermost layer of the nanoparticles may include a (meth)acrylate having a glass transition temperature Tg of about 70° C. or more. The structure wherein the core or the shell is composed of two or more layers may further improve the durability and stability of the adhesive film.

In the nanoparticles, the core and the shell may be present in a weight ratio of about 1:1 to about 9:1, for example, about 1:1 to about 5:1 (i.e., the core:the shell). Within this range of weight ratio, the adhesive film may exhibit good warpage characteristics and durability.

The nanoparticles may be present in an amount of about 0.01 parts by weight to about 20 parts by weight, for example, about 0.1 parts by weight to about 15 parts by weight, about 0.1 parts by weight to about 10 parts by weight, or, about 0.1 parts by weight to about 5 parts by weight, based on 100 parts by weight of the monomer mixture forming the (meth)acrylic copolymer containing hydroxyl group. Within this range of the nanoparticles, the adhesive film may have property balance (e.g., a balanced performance) among the warpage characteristics, durability and adhesive strength.

In other embodiments, the adhesive composition may further include at least one of an initiator, a crosslinking agent and a silane coupling agent.

The initiator may be a radical photo initiator, and may be the same or different from the initiator used in the preparation of the (meth)acrylic copolymer containing hydroxyl group. In other embodiments, the initiator may be a thermal initiator.

In some embodiments, the initiator may be present in an amount of about 0.001 parts by weight to about 5 parts by weight, for example, about 0.003 parts by weight to about 3 parts by weight, or about 0.1 parts by weight to about 1 part by weight, based on 100 parts by weight of the monomer mixture forming the (meth)acrylic copolymer containing hydroxyl group. Within this content range, the initiator may permit complete (e.g., substantially complete) curing of adhesive composition, reduce or prevent deterioration in transmittance of the adhesive film due to unreacted initiator, and exhibit good reactivity and good warpage characteristics under severe conditions.

The crosslinking agent may be a polyfunctional (meth)acrylate. Examples of the polyfunctional (meth)acrylate may include: bifunctional (meth)acrylates such as 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclodecane dimethanol (meth)acrylate, dimethylol dicyclopentane di(meth)acrylate, ethylene oxide-modified hexahydrophthalic di(meth)acrylate, tricyclodecane dimethanol (meth)acrylate, neopentyl glycol-modified trimethylpropane di(meth)acrylate, adamantane di(meth)acrylate, and 9,9-bis[4-(2-acryloyloxyethoxy)phenyl]fluorine; trifunctional (meth)acrylates such as trimethylolpropane tri(meth)acrylate, dipentaerythritol tri(meth)acrylate, propionic acid-modified dipentaerythritol tri(meth)acrylate, pentaerythritol tri(meth)acrylate, and propylene oxide-modified trimethylolpropane tri(meth)acrylate, trifunctional urethane (meth)acrylates, and tris(meth)acryloxyethylisocyanurate; tetrafunctional (meth)acrylates such as diglycerin tetra(meth)acrylate and pentaerythritol tetra(meth)acrylate; pentafunctional (meth)acrylates such as dipentaerythritol penta(meth)acrylate; and hexafunctional (meth)acrylates such as dipentaerythritol hexa(meth)acrylate, caprolactone-modified dipentaerythritol hexa(meth)acrylate, and urethane (meth)acrylates (for example, reaction products of an isocyanate monomer and trimethylolpropane tri(meth)acrylate)), without being limited thereto. These crosslinking agents may be used alone or in combination thereof. In one embodiment, the crosslinking agent may be a polyfunctional (meth)acrylate of a polyhydric alcohol containing 2 to 20 hydroxyl groups to provide excellent durability.

The crosslinking agent may be present in an amount of about 0.01 parts by weight to about 5 parts by weight, for example, about 0.03 parts by weight to about 3 parts by weight, or about 0.1 parts by weight to about 0.3 parts by weight, based on 100 parts by weight of the monomer mixture forming the (meth)acrylic copolymer containing hydroxyl group. Within this range, the adhesive film may exhibit excellent adhesive strength and improved reliability.

The silane coupling agent may include siloxane and epoxy silane coupling agents, without being limited thereto. The silane coupling agent may be present in an amount of about 0.01 parts by weight to about 5 parts by weight, for example, about 0.01 parts by weight to about 2 parts by weight, or about 0.01 parts by weight to about 0.5 parts by weight, based on 100 parts by weight of the monomer mixture forming the (meth)acrylic copolymer containing hydroxyl group. Within this range, the adhesive film may have improved reliability.

The adhesive composition may further include typical additives, such as curing accelerators, ionic liquids, lithium salts, inorganic fillers, softeners, molecular weight regulators, antioxidants, anti-aging agents, stabilizers, adhesion-imparting resins, reforming resins (polyol, phenol, acrylic, polyester, polyolefin, epoxy, epoxidized polybutadiene resins, and the like), leveling agents, defoamers, plasticizers, dyes, pigments (coloring pigments, extender pigments, and the like), treating agents, UV blocking agents, fluorescent whitening agents, dispersants, heat stabilizers, photostabilizers, UV absorbers, antistatic agents, coagulants, lubricants, solvents, and the like.

The adhesive composition may have a viscosity at 25° C. of about 300 cPs to about 50,000 cPs. Within this range of viscosity, the adhesive composition may exhibit good coatabillity and thickness uniformity.

The adhesive composition does not include a solvent, thereby securing good warpage characteristics of the adhesive film under severe conditions.

### Adhesive Film

An adhesive film according to embodiments of the present invention may be formed of the adhesive composition as set forth above. For example, a mixture including a monomer mixture of the monomer, a homopolymer of which has a glass transition temperature Tg of about −150° C. to about 0° C., the (meth)acrylate containing hydroxyl group and/or the monomer containing carboxyl acid group, and/or the nanoparticles is polymerized, thereby preparing the (meth)acrylic copolymer containing hydroxyl group. Then, an adhesive composition is prepared by mixing the (meth)acrylic copolymer containing hydroxyl group with the initiator, the crosslinking agent, and/or the like, and is then subjected to UV curing. Alternatively, the (meth)acrylic copolymer containing hydroxyl group may be prepared by polymerizing the monomer mixture, followed by mixing the same with the nanoparticles, the initiator, the crosslinking agent and/or the silane coupling agent to prepare an adhesive composition, which in turn is subjected to UV curing.

Curing may be performed by irradiation at a wavelength of about 300 nm to about 400 nm at a dose of about 400 mJ/cm² to about 3,000 mJ/cm² under oxygen-free conditions using a low-pressure lamp. For example, the coated adhesive composition may be cured at a dose of about 1,000 mJ/cm² to about 20,000 mJ/cm², without being limited thereto.

The adhesive film formed of the adhesive composition may have a warpage value of about 0.15 mm or less, for example, about 0.10 mm or less, or about 0.08 mm or less. Within this range, the adhesive film may exhibit good warpage characteristics and durability, and may not cause deformation of a member or a device including the adhesive film. The warpage value refers to the greatest height difference value among height difference values between a central point on the adhesive film and six other points on the adhesive film (four corner points of the adhesive film and two middles points on two 100 mm long sides thereof) on a flat surface, as measured after the adhesive film (size: 60 mm×100 mm×60 mm×100 mm, thickness: 100 μm, for example, in rectangular form) has been left under conditions of 60° C. and 90% RH for 500 hours.

The adhesive film may have an adhesive strength of about 800 gf/in to about 1,500 gf/in, for example, about 850 gf/in to about 1,500 gf/in, or about 900 gf/in to about 1,500 gf/in, as measured on a 100 μm thick specimen at 25° C. Within this range of adhesive strength, the adhesive film may not suffer from slight lifting and exhibit good durability.

The adhesive film may have an adhesive strength of about 500 gf/in to about 1,200 gf/in, for example, about 550 gf/in to about 1,200 gf/in, or about 600 gf/in to about 1,200 gf/in, as measured on a 100 μm thick specimen at 60° C. Within this range of adhesive strength, the adhesive film may exhibit good adhesion and durability even when the adhesive film has a curved shape.

The adhesive film may have a haze of about 1% or less, for example, about 0.99% or less, about 0.98% or less, or, about 0.01% to about 0.99%, in the visible range (for example, in the wavelength range of 380 nm to 780 nm), as measured on a 100 μm thick specimen after being left at 25° C. and 80% RH for 8 hours. Within this range, the adhesive film may exhibit good transparency when used in an optical display.

The adhesive film may have a haze of about 5% or less, for example, about 2% or less, about 1% or less, or, about 0.01% to about 2%, in the visible range, as measured on a 100 μm thick specimen after stretching to 200% of an initial length thereof. Within this range, the adhesive film may exhibit good transparency when used in an optical display.

The adhesive film may be used as a transparent adhesive film, or may be formed on an optical film to be used as an adhesive optical film. The optical film may be, for example, a polarizing plate. The polarizing plate includes a polarizer and a protective film on the polarizer, and may further include a hard coating layer and an anti-reflective layer.

### Display Member

A further aspect of the present invention relates to a display member. Hereinafter, a display member including the adhesive film according to the embodiment of the invention will be described.

The display member may include an optical film; and the adhesive film attached to one or both surfaces of the optical film.

The drawing is a cross-sectional view of a display member according to one embodiment of the present invention.

Referring to the drawing, a display member 100 according to one embodiment includes an optical film 20 and an adhesive film 10 according to the embodiments of the present invention, which is attached to one surface of the optical film 20.

The adhesive film 10 is an adhesive layer attached to one or both surfaces of the optical film, and may be used to attach glass plates, substrates, touch panel electrodes, an LCD/OLED module and a touch panel, optical films, and the like to each other.

Examples of the optical film may include touch panels, windows, polarizing plates, color filters, retardation films, elliptical polarizing films, reflective films, anti-reflective films, compensation films, brightness improving films, alignment films, light diffusion films, surface protective films, OLED device barrier layers, plastic LCD substrates, indium tin oxide (ITO)-containing films, fluorinated tin oxide (FTO)-containing films, aluminum-doped zinc oxide (AZO)-containing films, carbon nanotube (CNT)-containing films, Ag nanowire-containing films, and graphene transparent electrode films. These optical films may be manufactured by those of ordinary skill in the art.

For example, the adhesive film may be attached to a flexible device, a foldable device and a touchpad to be attached to a window, an optical film or an optical device so as to form a touch panel.

In another embodiment, a display may include a capacitive mobile phone as an optical display.

Hereinafter, embodiments of the present invention will be described in more detail with reference to some examples. It should be understood that these examples are provided for illustration only and are not to be construed in any way as limiting the scope of the present invention.

A description of details apparent to those skilled in the art will be omitted for clarity.

### EXAMPLE

### (A) Monomer Mixture

(a1) Butyl acrylate (BA) was used.

(a2) 2-ethylhexyl acrylate (EHA) was used.

(a3) 2-hydroxyethyl acrylate (HEA) was used.

### (B) Nanoparticles

Nanoparticles of a core-shell structure composed of a core of polybutyl acrylate (PBA) and a shell of polymethyl methacrylate (PMMA) (in a weight ratio of core to shell of 2.33:1, which is the weight of the core:the weight of the shell) (average particle diameter: 130 nm, cohesive energy: 33,830 J/mol) was used.

(b2) Organic particles of polymethyl methacrylate (PMMA, AL-010M, average particle diameter: 1 μm, cohesive energy: 33,830 J/mol, Samsung SDI) were used.

### Example 1

0.5 parts by weight of (b1) nanoparticles and 0.04 parts by weight of a photo initiator (Irgacure 651, Ciba Chemical Co., Ltd.) were sufficiently mixed with 100 parts by weight of a monomer mixture comprising 79 wt % of (a1) butyl acrylate, 9 wt % of (a2) 2-ethylhexyl acrylate and 12 wt % of (a3) 2-hydroxyethyl acrylate, in a glass container. Oxygen dissolved in the glass container was purged using nitrogen gas, followed by polymerizing the mixture through UV irradiation for a few minutes using a low-pressure lamp (50 mW/cm², wavelength: 350 nm, BL lamp, Sankyo Co., Ltd.), thereby obtaining a (meth)acrylic copolymer containing hydroxyl group having a viscosity of about 1,000 cPs. 0.28 parts by weight of an initiator (Irgacure 184, Ciba Chemical Co., Ltd.) and 0.2 parts by weight of HDDA (1,6-hexanediol diacrylate) as a crosslinking agent were added to the (meth)acrylic copolymer containing hydroxyl group, thereby preparing an adhesive composition.

The prepared adhesive composition was coated to a thickness of 100 μm onto a polyester film (release film, polyethylene terephthalate film, thickness: 35 μm). An upper side of the film was covered with a 35 μm thick release film, followed by irradiating both surfaces of the adhesive film for 6 minutes using a low-pressure lamp (50 mW/cm², wavelength: 350 nm, BL lamp, Sankyo Co., Ltd.), thereby obtaining an adhesive film.

### Example 2 to 4 and Comparative Example 1

Adhesive films were manufactured in the same manner as in Example 1 except that the amount of each of the components in Example 1 was changed as listed in Table 1.

The adhesive films prepared in Examples 1-4 and Comparative Example 1 were evaluated as to the following properties as listed in Table 1. Results are also shown in Table 1.

TABLE 1

| | | | | | | Comparative |
|---|---|---|---|---|---|---|
| | | Example | | | | Example |
| | | 1 | 2 | 3 | 4 | 1 |
| (A) (parts by | (a1) | 79 | 79 | 65 | 79 | 25 |
| weight) | (a2) | 9 | 9 | 12 | 9 | 67 |
| | (a3) | 12 | 12 | 23 | 12 | 8 |
| (B) (parts by | (b1) | 0.5 | 2 | 2 | — | 2 |
| weight) | (b2) | — | — | — | 0.5 | — |
| Cohesive energy of (B) | | 33,830 | 33,830 | 33,830 | 33,830 | 33,830 |
| nanoparticles (J/mol) | | | | | | |
| Cohesive energy of | | 51,290 | 51,290 | 53,559 | 51,290 | 62,076 |
| matrix (J/mol) | | | | | | |
| Warpage value | | 0 | 0 | 0 | 0.07 | 0.2 |
| (unit: mm) | | | | | | |
| Cohesive energy | | 17,460 | 17,460 | 19,729 | 17,460 | 28,246 |
| difference (J/mol)* | | | | | | |
| Adhesive | 25° C. | 928 | 1014 | 980 | 947 | 982 |
| strength | 60° C. | 633 | 709 | 688 | 650 | 581 |
| (gf/in) | | | | | | |

| | | | | | |
|---|---|---|---|---|---|
| Durability | ∘ | ∘ | ∘ | ∘ | x |
| Haze (%) | 0.46 | 0.76 | 0.93 | 0.98 | 1.42 |
| Haze after 200% | 0.54 | 0.82 | 0.98 | 1.01 | 1.56 |
| stretching (%) | | | | | |

*Cohesive energy difference: cohesive energy of matrix − cohesive energy of nanoparticles

### Property Evaluation

(1) Cohesive energy: Cohesive energy values of nanoparticles and a matrix were calculated according to Group Contribution Equation stated in Polymer Eng. and Sci. (Fedors, R. F., 1974, 14,147), respectively.

(2) Warpage value: An adhesive film specimen (size: 60 mm×100 mm×60 mm×100 mm, thickness: 100 μm, rectangular shape) was left under conditions of 60° C. and 90% RH for 500 hours, and height differences between a central point and six other points on the adhesive film (four corner points of the adhesive film specimen and two middles points on two 100 mm long sides thereof) on a flat surface were calculated. The greatest height difference value was determined as a warpage value.

(3) Adhesive strength at 25° C.: 90° adhesive strength was measured on the adhesive film (thickness: 100 μm), which was attached to a PET film (thickness: 35 μm) and subjected to aging at 25° C. for 30 minutes, using a TA.XT_Plus texture analyzer at 25° C. and at a peeling rate of 50 mm/min.

(4) Adhesive strength at 60° C.: 90° adhesive strength was measured on the adhesive film (thickness: 100 μm), which was attached to a PET film (thickness: 35 μm) and subjected to aging at 25° C. for 1 day and at 60° C. for 30 minutes sequentially, using a TA.XT_Plus texture analyzer at 60° C. and at a peeling rate of 50 mm/min.

(5) Durability: A glass plate was stacked on the adhesive film (thickness: 100 μm) placed on an ITO film to prepare a specimen. Then, the specimen was subjected to autoclaving and left under conditions of 60° C. and 90% RH for 500 hours. The specimen was observed through the naked eye for any slight lifting, detachment or bubble generation at interfaces of the adhesive film. No bubbling or detachment was rated as ◯, slight bubbling or detachment was rated as A, and severe bubbling or detachment was rated as x.

(6) Haze: After the adhesive film was left under conditions of 25° C. and 80% RH for 8 hours, haze was measured on a 100 μm thick specimen of the adhesive film using a haze meter (NDH 5000, Nippon Denshoku Co., Ltd.) in accordance with American Society for Testing and Measurement (ASTM) D1003-95 (Standard Test for Haze and Luminous Transmittance of Transparent Plastic).

(7) Haze after 200% stretching: Both ends of a sample (13 cm×3 cm×13 cm×3 cm, thickness: 100 μm) of the adhesive film were secured to both sides of a horizontal tensile tester, followed by removing the release films from both surfaces of the sample. Then, with the sample stretched to an elongation of 200% in the longitudinal direction, a glass plate was placed on a lower side of the sample and a release film was placed on an upper side of the sample, followed by bonding the sample to the glass plate using 2 kg rollers, thereby preparing a stretched specimen. Next, the release film was removed from the upper side, followed by measuring the haze of the specimen having a thickness of 100 μm in the same manner as described above.

As shown in Table 1, it can be seen that the adhesive films of Examples 1-4 exhibited good properties in terms of warpage characteristics, adhesive strength, transparency, haze, and durability. Accordingly, the present invention provides an adhesive film having good properties in terms of warpage characteristics, adhesive strength, transparency and durability, and a display member including the same.

Conversely, the adhesive films of Comparative Example 1 failed to satisfy the requirements for warpage, durability, transparency and haze characteristics.

Although some embodiments have been described herein, it should be understood that these embodiments are given by way of illustration only, and that various modifications, changes, alterations, and equivalent embodiments can be made by those skilled in the art without departing from the spirit and scope of the invention. Therefore, the scope of the invention should be limited only by the accompanying claims and equivalents thereof.

What is claimed is:

1. An adhesive film comprising:
a matrix comprising a (meth)acrylic copolymer containing hydroxyl group; and
nanoparticles dispersed in the matrix,
wherein the adhesive film has a haze of about 1% or less, as measured after the adhesive film has been left under conditions of 25° C. and 80% RH for 8 hours, and a warpage value of about 0.15 mm or less after the adhesive film has been left under conditions of 60° C. and 90% RH for 500 hours.

2. The adhesive film according to claim 1, wherein a difference in cohesive energy between the matrix and the nanoparticles is about 20,000 J/mol or less.

3. The adhesive film according to claim 1, wherein the nanoparticles are organic particles.

4. The adhesive film according to claim 3, wherein the organic particles comprise a (meth)acrylate having a glass transition temperature Tg of about 70° C. or more.

5. The adhesive film according to claim 3, wherein the organic particles have a core-shell structure, a shell of the core-shell structure comprising a (meth)acrylate having a glass transition temperature Tg of about 70° C. or more.

6. The adhesive film according to claim 4, wherein the (meth)acrylate having a glass transition temperature Tg of about 70° C. or more comprises at least one of polymethyl methacrylate (PMMA) and isobornyl acrylate (IBOA).

7. The adhesive film according to claim 1, wherein the nanoparticles have an average particle diameter of about 5 nm to about 1,000 nm.

8. The adhesive film according to claim 1, wherein the nanoparticles are present in an amount of about 0.01 parts by weight to about 20 parts by weight based on 100 parts by weight of a monomer mixture forming the (meth)acrylic copolymer containing hydroxyl group.

9. The adhesive film according to claim 1, wherein the (meth)acrylic copolymer containing hydroxyl group is a copolymer of a monomer mixture comprising a (meth)acrylic monomer containing hydroxyl group and a monomer, a homopolymer of which has a glass transition temperature Tg of about −150° C. to about 0° C.

10. The adhesive film according to claim 9, wherein the monomer mixture further comprises a monomer containing carboxyl acid group.

11. The adhesive film according to claim 9, wherein the (meth)acrylic monomer containing hydroxyl group is present in an amount of about 5 wt % to about 35 wt % in the monomer mixture.

12. The adhesive film according to claim 1, wherein the adhesive film is formed of an adhesive composition comprising the (meth)acrylic copolymer containing hydroxyl group and the nanoparticles.

13. The adhesive film according to claim 12, wherein the adhesive composition further comprises at least one of an initiator, a crosslinking agent and a silane coupling agent.

14. The adhesive film according to claim 1, wherein the adhesive film has an adhesive strength of about 800 gf/in to about 1,500 gf/in, as measured on a 100 μm thick specimen at 25° C.

15. The adhesive film according to claim 1, wherein the adhesive film has an adhesive strength of about 500 gf/in to about 1,200 gf/in, as measured on a 100 μm thick specimen at 60° C.

16. The adhesive film according to claim 1, wherein the adhesive film has a haze of about 1% or less, as measured on a 100 μm thick specimen after being left at 25° C. and 80% RH for 8 hours.

17. The adhesive film according to claim 1, wherein the adhesive film has a haze of about 5% or less, as measured on a 100 μm thick specimen after stretching to 200% an initial length thereof.

18. A display member comprising:
an optical film; and
the adhesive film according to claim 1 attached to one or both surfaces of the optical film.

19. The display member according to claim 18, wherein the optical film comprises touch panels, windows, polarizing plates, color filters, retardation films, elliptical polarizing films, reflective films, anti-reflective films, compensation films, brightness improving films, alignment films, light diffusion films, surface protective films, OLED device barrier layers, plastic LCD substrates, indium tin oxide (ITO)-containing films, fluorinated tin oxide (FTO)-containing films, aluminum-doped zinc oxide (AZO)-containing films, carbon nanotube (CNT)-containing films, Ag nanowire-containing films, or graphene.
